(19) United States
(12) Patent Application Publication
(10) Pub. No.: US 2009/0308679 A1
(43) Pub. Date: Dec. 17, 2009

(54) Driver fatigue status detector device

(76) Inventor: ION MURGU, Parma, OH (US)

Correspondence Address: Ion Murgu, 2409 Grantwood Drive, Parma, OH, 44134, US

(21) Appl. No.: 12/139,548

(22) Filed: Jun. 16, 2008

(51) Int. Cl. B60R 21/00; G08B 23/00

(52) U.S. Cl. 180/271; 340/576

(57) ABSTRACT

Two linear array of switches (on/off non pressed/pressed) what can provide a quantified multilevel electric signals (on/off) to a computer for a real time analyze of driver status and dozen advertise.

In a correct driving a driver grip with both hands the steering wheel in a symmetric position of the hands.

This grip is a volition act and is ending when the volition is disturbed. The fatigue is a disturbing process and volatile or extinguish the volition acts. The grip process is a non-reflex process but have a short retentivity (vestigial) but for extremity of fingers this effect is practically null then it can to be used to build a driver fatigue apparatus.

This apparatus needed a device what to detect status of every finger (griping/non-griping) and a long study was leading my to a symmetric linear array of repeatable of 4 or 5 or 6 linear on/off switches keyboard what mean cells and a keyboard controller what tie together into linear elastic keyboard device what is the base key of driver fatigue status apparatus.

The switches design remain for another claim but must to be related with it for a well function of driver fatigue status apparatus.

This elastic linear keyboard will be posted in a position on steering wheel to be in contact with extremity of the driver fingers, so every finger will grip a switch all the time what the volition process to do it will be not disturbed. Then every switch what is griped will put on ON it's circuit line and a programmable controller will read every time it's status. A driver fatigue status apparatus will contain a symmetric two linear array of repeatable cells providing for every hands position to collect enough signals for driver fatigue status and will be a good sensor for a drunk driver too.

The device described connected to a computer what to take time with time a input signal from device to analyze it and to release many outputs. The computer will contain more subroutines.

A subroutine what to read periodically device status a multiple ON/OFF signals and to send it to a buffer.

A subroutine what to check at every start the device for malfunctions.

A subroutine what for time real analyze of the buffer signals and to provide a time real outputs (alerts).

A subroutine what to collect the buffer signals and to send it to a file or a data base.

A subroutine what to use the file inputs for a short time analyze and the answer to be a output for a gauge driver status.

A subroutine what to use the file inputs for a long time analyze and the answer to be a driver personality analyze.

A subroutine what to control reset button.

This program shortly described above remain for another claim but must to be related with it for a well function of driver fatigue status apparatus.

The design and constructive for switches remain for another claims because it's must to be assorted with every sort of steering wheel and in the future will be incorporate in the steering wheel.

### DRAWINGS DESCRIPTION

FIG. 1. Describe how the switches are distribute in two linear array forming cells virtual connected to 4 or 5 or 6 characters for left linear array and another 4-5 or 6 for the right linear array.

FIG. 2. Describe how both linear array connected to a controller keyboard will be capable to provide Input signals to a computer at short intervals of time and the computer to do a analyze under a program and to provide multiple outputs to a gauge fatigue status or a multiple advertiser.

FIG. 3. Explain the connection of every switch of repeatable cells to the electric connectors.

FIG. 4. Explain the position of the switches on steering wheel to be griped of extremity of the fingers.

FIG. 5. Refer what parts of the fingers is optimal for contact switches.

FIG. 6. Is a virtual sequential buffer of inputs signals.

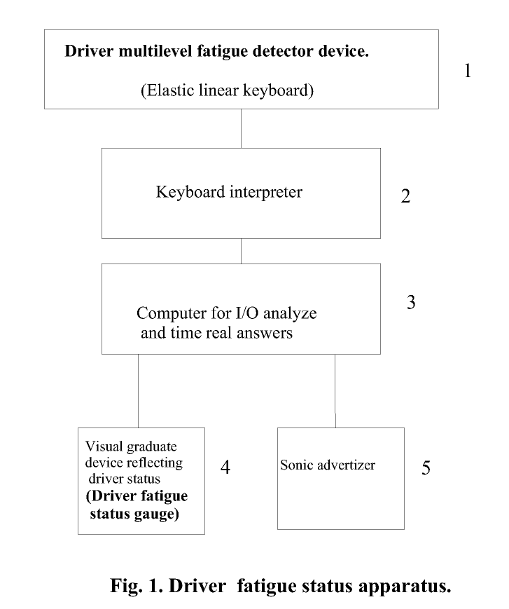

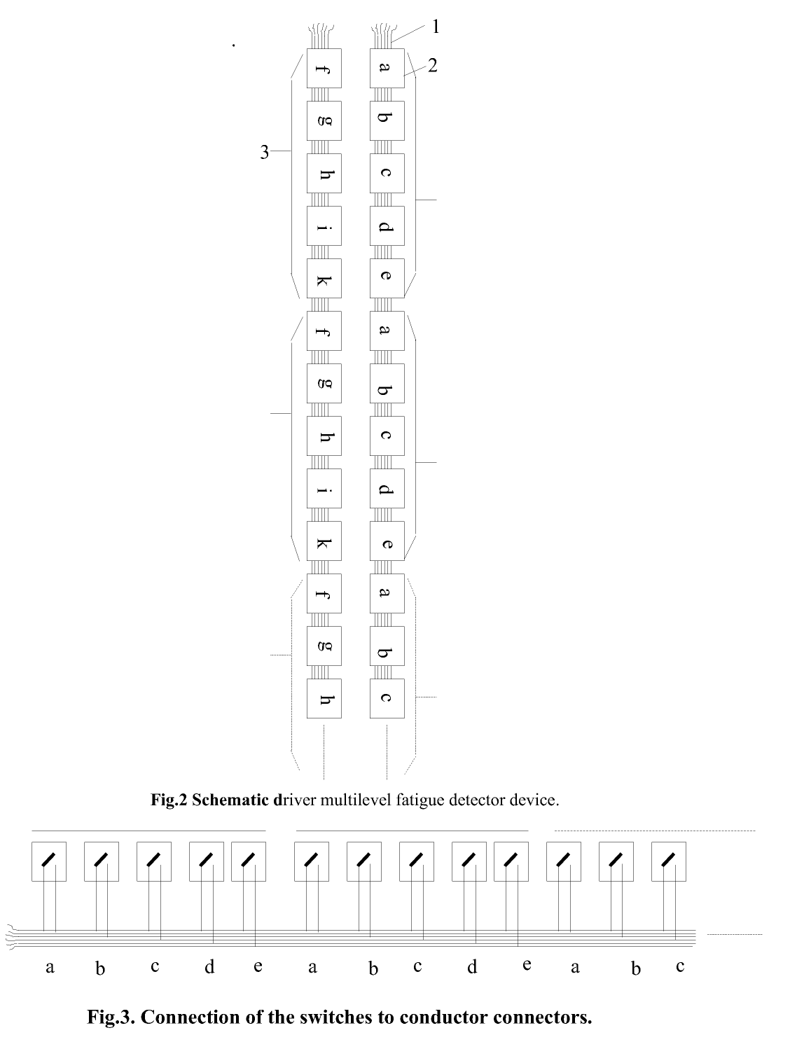

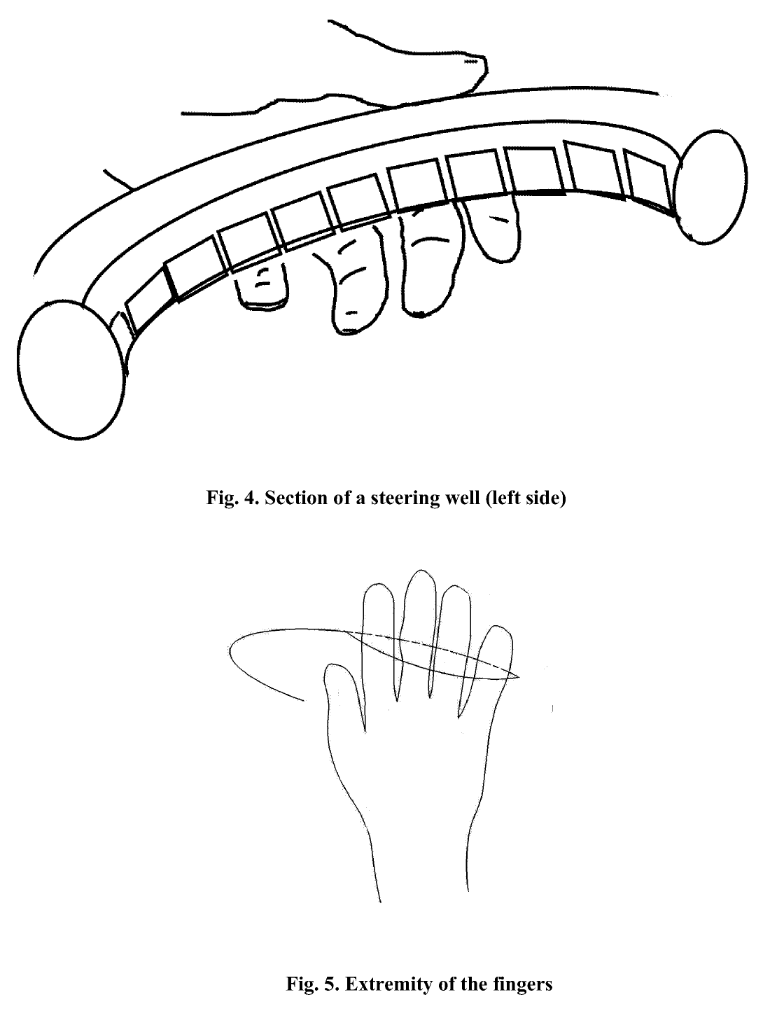

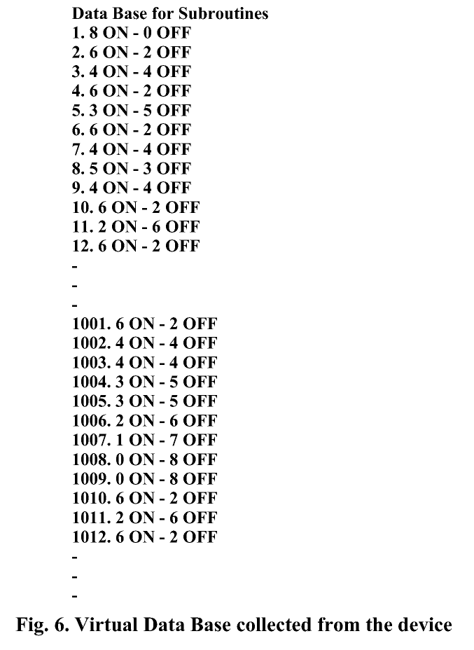

1. A cell of 4 or 5 or 6 linear on/off switches (switches what are not claimed here because it's design and constructive method will be a matter of future) what can be properly designed to match on steering wheel.

2. Two linear array of repeatable cells claimed above one for left symmetric side of steering wheel and one for the right, circumferential on steering wheel in a position to be I contact with extremity of the fingers when those are griping the steering wheel.

3. A connection of this device to a controller (like Intel 8042 keyboard controller) what will make this device a linear keyboard or elastic linear keyboard what will provide a multilevel device for a quantified measurement of driver fatigue.

4. (canceled)

5. (canceled)

6. (canceled)

7. (canceled)

9. (canceled)

10. (canceled)

11. (canceled)

12. Usage of non-reflex flexion and extension of extremely fingers joints to provide a quantified signals. To grip a thing with the fingers is a volition action and a fatigue status is a disturbing process what volatile or extinguish the volition acts and using this is a new idea after a long time analyze.
